(19) United States
(12) Patent Application Publication
(10) Pub. No.: US 2013/0093267 A1
(43) Pub. Date: Apr. 18, 2013

(54) DRIVE UNIT FOR A WINDSCREEN WIPER DEVICE IN A VEHICLE AND HOUSING FOR A DRIVE UNIT

(71) Applicants: Werner Hartmann, Vaihingen/Enz (DE); Christof Heuberger, Freiberg (DE); Mathias Kindel, Tamm (DE); Siegfried Stefani, Oberriexingen (DE)

(72) Inventors: Werner Hartmann, Vaihingen/Enz (DE); Christof Heuberger, Freiberg (DE); Mathias Kindel, Tamm (DE); Siegfried Stefani, Oberriexingen (DE)

(73) Assignee: VALEO WISCHERSYSTEME GMBH, Bietigheim-Bissingen (DE)

(21) Appl. No.: 13/806,154

(22) PCT Filed: Jun. 28, 2011
(86) PCT No.: PCT/EP11/60786

§ 371 Date: Dec. 21, 2012

(30) Foreign Application Priority Data
Jun. 30, 2010 (DE) 10 2010 025 689.7

(51) Int. Cl. H02K 5/10; B60S 1/16

(52) U.S. Cl. CPC H02K 5/10; B60S 1/16
USPC 310/43

(57) ABSTRACT

The invention relates to a drive unit (10) for a windscreen wiper device in a vehicle with a multiple-section housing (11) with a drive motor (1), more particularly connected to the housing (11), which is at least indirectly controllable by means of conductor leads (17), more particularly in the form of punched components, whereby the conductor leads (17) end in a plug connection (14) of the housing (11) via which the drive motor (1) is externally electrically powered, whereby the housing (11), at least in the housing section (12; 12a to 12c) accommodating the conductor leads (17) is designed as an injection moulded component, in which the conductor leads (17) are at least partially overmoulded with the material of the housing section (12; 12a to 12c). In accordance with the invention it is envisaged that the conductor rods (17) are also arranged in a sealed manner on the inside of the housing (19) so that the penetration of moisture into at least the section of the inside of the housing (19) overmoulded by the material of the housing section (12, 12a to 12c) is prevented.

### PRIOR ART

The invention relates to a drive unit for a windscreen wiper device in a vehicle in accordance with the introductory section of claim 1. The invention also relates to a housing for a drive unit.

A drive unit of this type for a windscreen wiper device is already generally known. In particular for contacting a drive motor connected to a housing of the drive unit, conductor leads are used in the form of punched grids which normally have a rectangular cross section. The conductor leads terminate in a plug connection which is on the side of the housing facing away from the drive motor and is electrically contactable by means of a counter plug, more particularly a wiring harness.

During the operation of the drive unit it is essential that no moisture and/or no water enters the housing, as the conductor leads in the prior art are designed as insert parts for an injection moulding tool in which the conductor leads are arranged exposed on the inside of the housing. The penetration of water and/or moisture can therefore lead to corrosion or a short-circuit, which impairs the functioning of the drive unit. Although it is known to seal the housing, which is formed as two housing half shells, by arranging appropriate sealing elements in the parting plane between the housing half shells, moisture can still penetrate into the housing via a plug connector, which cannot be prevented by said seals. Furthermore, through temperature changes condensation can form inside the casing which also cannot be prevented by said sealing measures.

### DISCLOSURE OF THE INVENTION

On the basis of the described prior art, the aim of the invention is to further develop a drive unit for a windscreen wiper device in accordance with the introductory section of claim 1 in such a way that particularly reliable operation of the drive unit is guaranteed in that the penetration of moisture and/or water into the area of the conductor leads is definitively prevented. In accordance with the invention this is achieved on the basis of the characterising section of claim 1 in that the conductor leads are also arranged in a sealed manner on the inside of the housing so that the penetration of moisture is prevented at least in the areas of the inside of the housing overmoulded by the housing section material.

Advantageous further developments of the drive unit in accordance with the invention for a windscreen wiper device in a vehicle are set out in the sub-claims. All combinations of at least two of the features disclosed in the claims, the description and/or in the figures come under the scope of the invention.

In a first variant of embodiment of the invention it is envisaged that the conductor leads exhibit additional overmoulding, more particularly completely surrounding the cross-section of the conductor leads with the exception of the contacting areas. In other words this means that before being arranged in the tool for producing the casing section and/or being overmoulded by the material of the housing section, the conductor leads are provided with additional overmoulding in a separate production stage. The conductor leads provided in this way with the additional overmoulding can then be inserted into the appropriate tool for producing the housing section whereby the conductor leads can then be additionally overmoulded with the material of the housing section at least from the outside of housing.

In an alternative or additional form of embodiment it is envisaged that the conductor leads are provided with spacers which keep the conductor leads at a distance from the a tool forming the inside of the housing section, so that the conductor leads are completely overmoulded by the material of the housing section. In the first variant the conductor leads are not provided with additional overmoulding, but the conductor leads are arranged within the tool for producing the housing section in such a way that material of the housing fully covers the inner surface of the housing section so that the conducting leads are completely surrounded/overmoulded by the housing section material. This measure can, as claimed, be envisaged in addition to separate overmoulding the conductor leads.

As an alternative to overmoulding of the conductor leads, it is also conceivable for separating walls to be formed on the inside of the housing section between which the conductor leads are placed. In this case, although the metal sections of the conductor leads are exposed on the inside of the casing, through the formation of the separating wall it is at least more difficult for moisture/water to reach the individual conductor leads.

In another alternative form of embodiment of the invention it is envisaged that the conductors leads terminate at least approximately flush with the inside of the housing and that on its inner side the housing has, at least in the area of the conductor leads, an additional protective layer covering the conductor leads. In other words this means that the open conductor leads terminating approximately flush with the inside of the housing are covered with an additional protective layer which prevents the penetration of moisture and/or water.

Here it can be envisaged that the protective layer is formed as an additional coating. Such a coating can be, for example, a resin or similar coating. A coating of this type is preferably applied to the inside of the housing in a separate production stage after production of the housing.

Instead of a coating, the protective layer can also be in the form of a protective film, whereby the protective film preferably has an adhesive layer on the side facing the conductor leads. A protective film of this type is relatively easy to use, whereby with the provision of an adhesive layer it can be attached to the inside of the housing in a particularly simple and secure manner.

As a further alternative it is conceivable for the additional protective layer to be formed as a lacquer layer or as corrosion-inhibiting layer, e.g. in the form of a wax or grease layer.

In a further, particularly preferred form of embodiment of the invention it is envisaged that the conductor leads on the inside of the housing are covered with separate components, more particularly a plate-type component which is connected to the material of the housing.

In a specific embodiment of this variant of the invention it is envisaged that the (plate-type) component is at least partially overmoulded by the material of the housing. This makes for a firm and sealed connection of the component with the housing section, whereby the conductor leads are arranged protected in the desired manner between the component and the housing section.

Particularly preferred is a form of embodiment in which the component has guide means, more particularly in the form of separating walls, between which the conductor leads are arranged. This embodiment achieves the advantage that the component simultaneously serves to arrange/position the conductor leads in the tool for producing the housing. In this way, additional aids to position the conductor leads in the tool are avoided and particularly secure and clear assembly of the conductor leads in the housing section is made possible.

It is also preferred if the component has positioning means, more particularly in the form of positioning pins, which secure the conductor leads in the tool for producing the housing.

Further advantages, features and details of the invention as set out in the following description of preferred examples of embodiment as well as with the aid of the drawing.

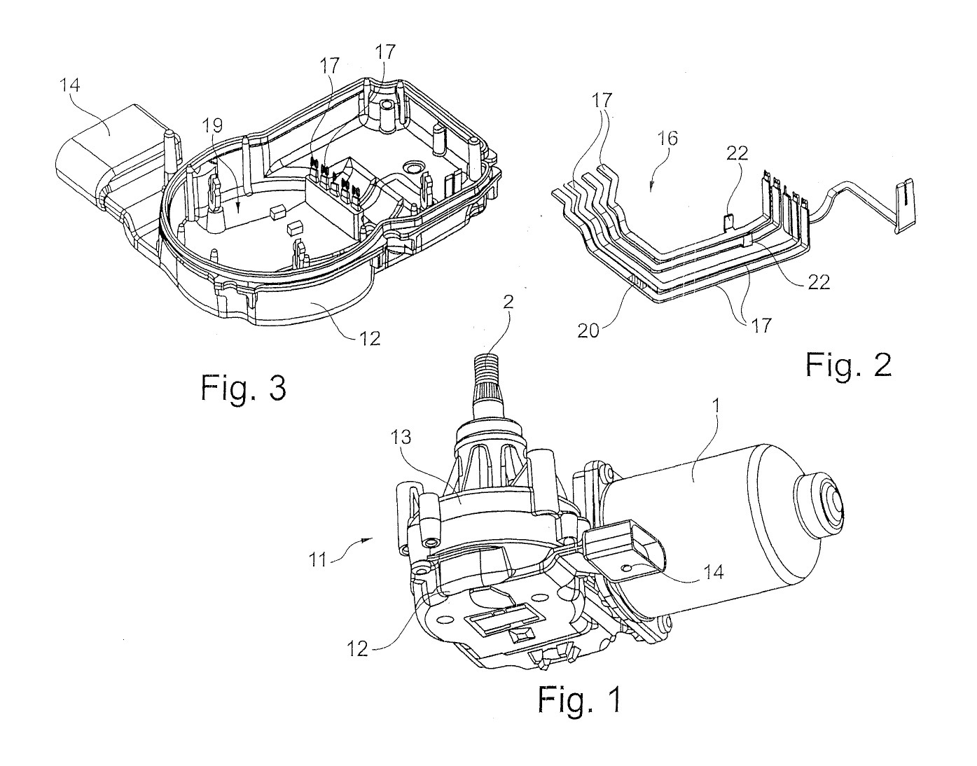

FIG. 1 shows a perspective view of a drive unit in accordance with the invention using a two-part housing

FIG. 2 shows a perspective view of conductor leads for use in a drive unit in accordance with FIG. 1

FIG. 3 shows a perspective view of a lower housing section with the conductor leads in accordance with FIG. 2

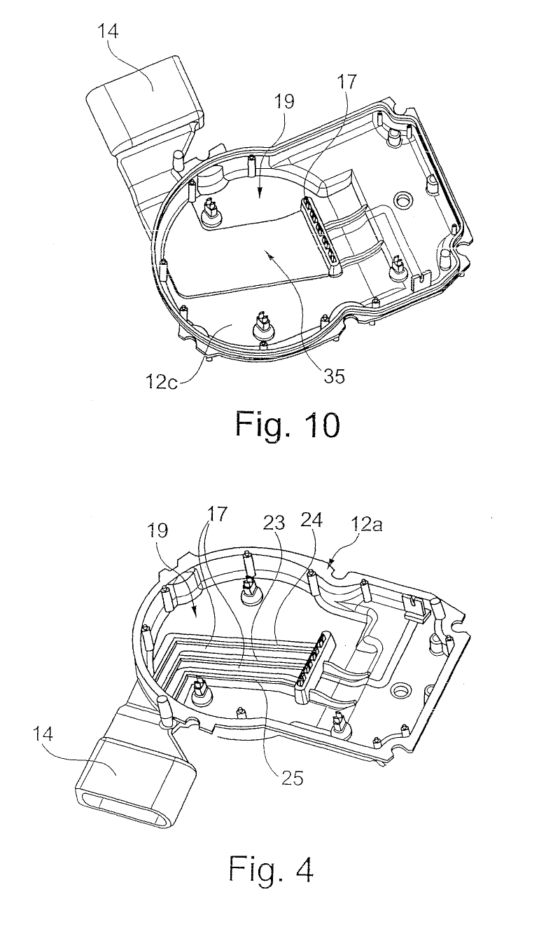

FIG. 4 shows a perspective view of a lower housing section using separating walls between the conductor leads

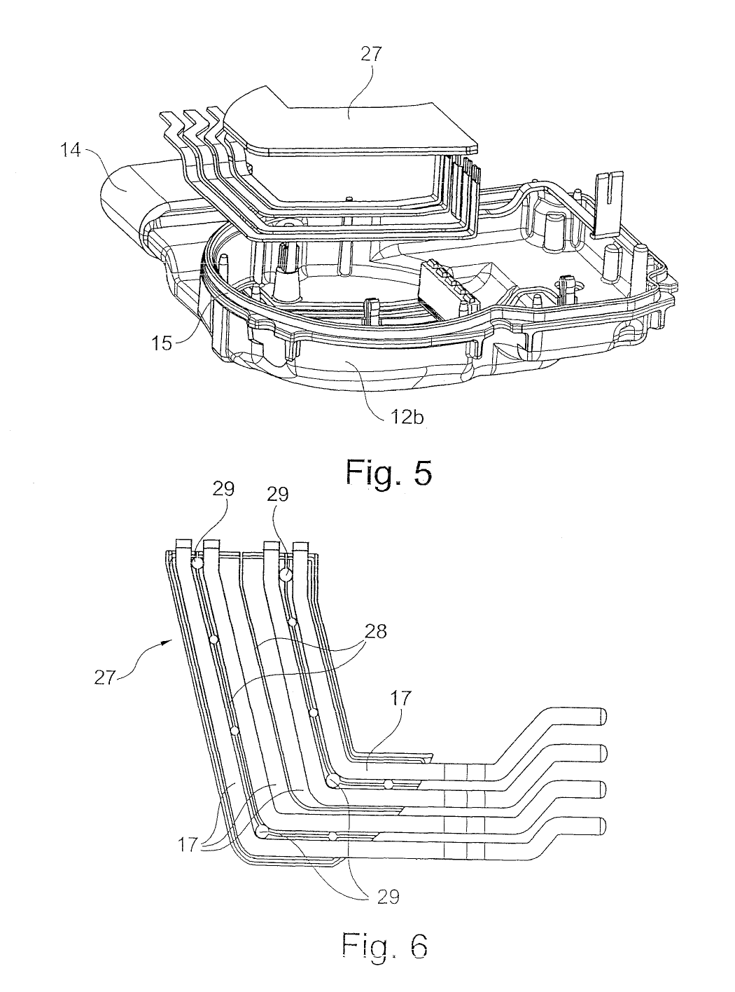

FIG. 5 shows a perspective view of a variant of the housing section using a separating cover plate

FIG. 6 shows a view of a cover plate in accordance with FIG. 5 with mounted conductor leads

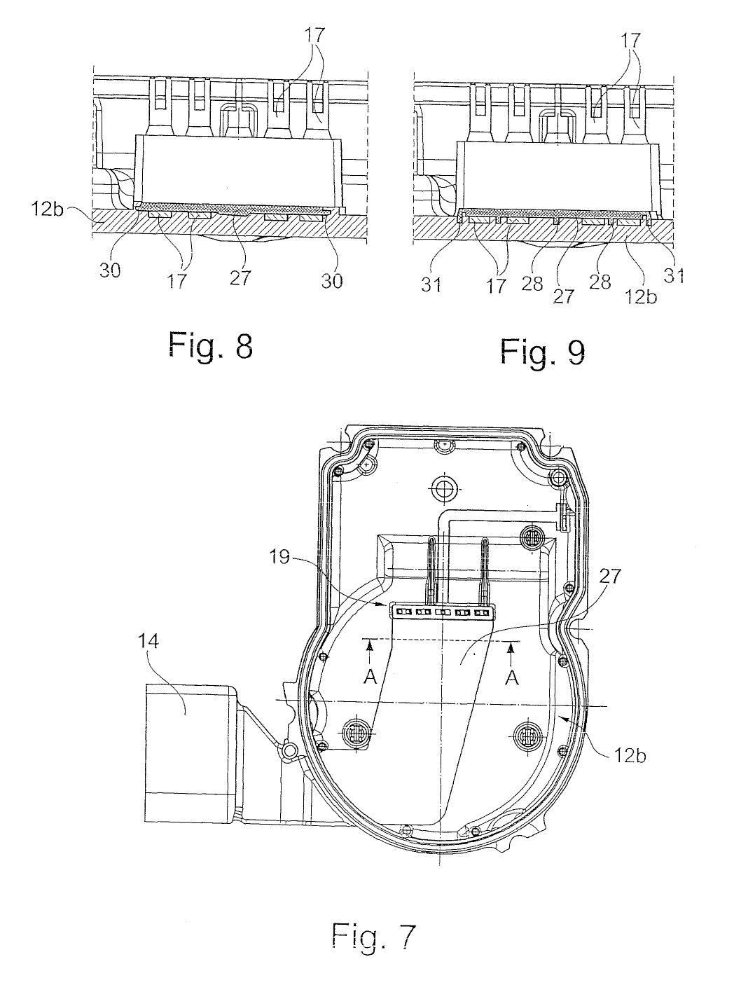

FIG. 7 shows view from above of the housing section in accordance with FIG. 5 in its overmoulded final state

FIG. 8 and

FIG. 9 show cross-sections along plane A-A in FIG. 7 in the area of the conductor leads and their cover plate and

FIG. 10 shows a perspective view of a further variant of a housing section using a cover layer for the conductor leads

Identical components and components with the same function are given the same reference numbers in the figures.

FIG. 1 shows a drive unit 10 for a windscreen wiper device in a vehicle. More particularly, in the example of embodiment the drive unit 10 a two-part housing 11 consists of a lower housing section 12 and an upper housing section 13. In the example of embodiment a plug connection 14 is formed in one piece on the outside of the lower housing section 12. It is of course also conceivable to arrange the plug connection 14 on the upper housing section 13. The lower housing section 12 is preferably produced as an injection moulded component and is made of plastic while the upper housing section 13 is produced as a die cast component and preferably consists of aluminium.

Flanged laterally on the housing 11 a drive motor 1, more particularly an electric motor, can be seen in FIG. 1. The drive unit 1 works together with a gear mechanism (which is not shown) arranged in the housing 11 and has an output shaft 2 for operating windscreen wipers. The drive motor 1 is electrically controlled via the plug connection 14, more particularly via a mating plug arranged on the wiring harness of the vehicle.

In order to prevent the penetration of water and/or moisture into the inside of the housing 11, the two housing sections 12, 13 are in practice usually provided with a circumferential seal 15 which can be seen in FIG. 5. More particularly, the two housing sections 12, 13 are screwed together.

As can be seen in particular in FIG. 2, a so-called punched grid 16, which in the example of embodiment has several conductor leads 17, is used for the electrical control of the drive motor 1. The conductor leads 17 which are rectangular in cross-section and/or the punched grid 16 are made of metal, whereby individual conductor leads 17 are punched out of a metal sheet and subsequently, possibly through an embossing process, are shaped as shown in FIG. 2.

The punched grid 16 and the conductor leads 17 are arranged in the lower section of the housing 12. As has already been stated, the lower section of the housing 12 is produced as an injection moulded component. This means that the lower section of the housing 12 is generally produced by means of a divided tool, whereby a recess is formed by the halves of the tool which after the injection of plastic forms the lower housing section 12. In the prior art the conductor leads are designed as insert components in the tool so that the sides of the conductor leads 17 facing the inner wall 19 of the lower housing section 12 are flush with the inner wall 19 of the lower housing section 12.

In order to protect the (open) sides of the conductor leads from the penetration of moisture and/or water, in accordance with the invention it is envisaged in a first embodiment of the invention to overmould the conductor leads 17 with plastic material 20 beforehand in a separate production stage (FIG. 2). Only after overmoulding of the conductor leads 17 with the plastic material 20 are they inserted into the corresponding tool so that the side of the conductor leads 17 facing the inner wall 19 is also surrounded by the plastic material 20.

In addition to or as an alternative to overmoulding of the conductor leads 17 with plastic material 20, the conductor leads 17 can be provided with holder webs 22 which act as spacers between the conductor leads 17 and one part of the tools for producing the lower housing section 12 which forms the inner wall 19 of the lower housing section 12. In other words this means that the holding webs 22 come into contact with the corresponding tool or the corresponding half of the tool, so that the conductor leads 17 are arranged in an intermediate area of the wall of the lower housing section 12. In this way the conductor leads 17 are completely overmoulded by the material of the lower housing section 12 during the production of the lower housing section 12 in accordance with FIG. 3.

In FIG. 4 a further form of embodiment of the invention is shown with a lower housing section 12a which has separating walls 23 to 25 between the conductor leads 17. These separating walls 23 to 25 are arranged between the individual conductor leads 17 and ensure that two conductor leads 17 at a distance from one another are separated by a separating wall 23 to 25.

In FIGS. 5 and 7 a lower housing section 12b of a further form of embodiment of the invention is shown, which has an addition component in the form of a cover plate 27. In accordance with FIG. 6 the cover plate 27, which is made of plastic in a separate production process, has separating walls 28 between the individual conductor leads 17 which are used for positioning and/or assembling of the conductor leads 17 on the cover plate 27. In addition, on the cover plate 27 there are positioning pins 29 which project beyond the conductor leads 17 perpendicularly to the drawing plane of FIG. 6 and define and secure the position of the conductor leads 17 in the tool during the production of the lower housing section 12b. The cover plate 27 is preferably also produced as an injection moulded component. To produce the lower housing section 12b with the conductor leads 17 and cover plate 27 arranged therein, in a first production stage the cover plate 27 is provided/equipped with the conductor leads 17. The thus prefabricated unit is then inserted into the tool for producing the lower housing section 12b. After closing the tool, plastic material is injected into the tool, whereby the area of the cover plate 27, as can be seen in particular in FIGS. 8 and 9, is completely surrounded with plastic on the side facing away from the conductor leads 17. If is particularly preferred if, in accordance with FIGS. 8 and 9, the cover plate 27 has edge areas 30, 31 which are completely surrounded and/or overmoulded by the material of the lower housing section 12b so that an internal connection between the cover plate 27 and the lower housing section 12b is made possible. At the same time, such edge areas 30, 31 also prevent the penetration of moisture and/or water into the space between the cover plate 27 and the lower housing section 12b.

In addition it should be mentioned that in the form of embodiment shown in FIG. 8 the cover plate 27 has no separating walls 28 at least in the area shown in FIG. 8.

In the further embodiment of the invention shown in FIG. 10, the conductor leads 17 placed in the lower housing section 12c and open in the area of the inner wall 19 are covered by a protective layer 35. This protective layer 35 can be produced as an additional coating, e.g. in the form of a resin coating. Alternatively it is also possible for the proactive layer 35 to be a protective film, whereby the protective film preferably has an adhesive layer on the side facing the conductor leads 17.

Alternatively it is possible for the protective layer 35 to be designed as a lacquer layer or as an anticorrosion layer, e.g. in the form of a wax or grease layer. The thus described drive unit 10 can be modified and/or altered in many different ways without departing from the inventive concept. This consists in the protection of the conductor leads 17 in the area of the inner wall 19 of the lower housing section 12, 12a, 12b, 12c in order to prevent the penetration of moisture or water to the conductor leads 17 or to make it more difficult.

### LIST OF REFERENCES

1 Drive motor

2 Drive shaft

10 Drive unit

11 Housing

12, 12a Lower housing section

12b, 12c Lower housing section

13 Upper housing section

14 Plug connection

15 Seal

16 Punched grid

17 Conductor leads

19 Inside wall

20 Plastic material

22 Holding webs

23 Separating wall

24 Separating wall

25 Separating wall

27 Cover plate

28 Separating walls

29 Positioning pin

30, 31 Edge area

35 Protective layer

1. A drive unit for a windscreen wiper device in a vehicle with a multiple-section housing with a drive motor connected to the housing, wherein the drive motor is at least indirectly controllable by means of conductor leads in the form of punched components, whereby the conductor leads end in a plug connection of the housing via which the drive motor is externally electrically powered, whereby the housing, at least in the housing section accommodating the conductor leads is designed as an injection moulded component, in which the conductor leads are at least partially overmoulded with a material of the housing section, wherein the conductor rods are also arranged in a sealed manner on the inside of the housing so that the penetration of moisture into at least a section of an inside of the housing overmoulded by the material of the housing section is prevented.

2. The drive unit in accordance with claim 1, wherein the conductor leads have additional overmoulding of plastic fully surrounding the cross-section of the conductor leads with the exception of contacting areas.

3. The drive unit in accordance with claim 1, wherein the conductor leads are provided with spacer means which keep the conductor leads at a distance from a tool forming the inside of the housing section so that the conductor leads are fully overmoulded by the material of the housing section.

4. The drive unit in accordance with claim 1, wherein on the inside of the housing section separating walls are formed between which the conductor leads are arranged.

5. The drive unit in accordance with claim 1, wherein the conductor leads end at least approximately flush with the inside of the housing and that the housing section on the inside has, at least in the area of the conductor leads, an additional protective layer covering the conductor leads.

6. The drive unit in accordance with claim 5, wherein the protective layer is designed as an additional coating.

7. The drive unit in accordance with claim 5, wherein the protective layer is a protective film where, on the side facing the conductor leads, the protective film has an adhesive layer.

8. The drive unit in accordance with claim 5, wherein the additional protective layer is a lacquer layer or an anticorrosive layer.

9. The drive unit in accordance with claim 1, wherein the conductor leads are covered on the inside of the housing by a separate plate-shaped component that is connected with the material of the housing section.

10. The drive unit in accordance with claim 9, wherein the component is at least partially overmoulded by the material of the housing section.

11. The drive unit in accordance with claim 9, wherein the component has separating walls between which the conductor leads are arranged.

12. The drive unit in accordance with claim 9, wherein the component has positioning pins which secure the conductor leads in a tool for producing the housing section.

13. A housing for a drive unit in accordance with claim 1.
